(19) United States
(12) Patent Application Publication
(10) Pub. No.: US 2013/0015739 A1
(43) Pub. Date: Jan. 17, 2013

(54) ELECTRICAL DRIVE COMPRISING A WORM GEAR

(71) Applicants: Guenter Kastinger, Gaggenau-Sulzbach (DE); Mario Huesges, Buehlertal (DE); Andreas Saum, Buehl (DE)

(72) Inventors: Guenter Kastinger, Gaggenau-Sulzbach (DE); Mario Huesges, Buehlertal (DE); Andreas Saum, Buehl (DE)

(73) Assignee: ROBERT BOSCH GMBH, Stuttgart (DE)

(21) Appl. No.: 13/520,314

(22) PCT Filed: Nov. 3, 2010
(86) PCT No.: PCT/EP2010/066686

§ 371 Date: Oct. 1, 2012

(30) Foreign Application Priority Data
Dec. 30, 2009 (DE) 10 2009 055 396.7

(51) Int. Cl. H02K 7/116

(52) U.S. Cl. 310/83

(57) ABSTRACT

An electrical drive, especially for driving a windshield wiper system of a motor vehicle, comprises a worm gear having a worm shaft and a drive motor having a rotor. The rotor and the worm gear are arranged on axial sections of a shaft. The electrical drive furthermore comprises two shaft bearings on which the shaft is received, only one of said shaft bearings being arranged on the shaft in the vicinity of the rotor.

### BACKGROUND OF THE INVENTION

Electrical drives, for example, for use in motor vehicles frequently comprise an electrical drive motor and a reduction gear or a countershaft gearbox. By means of a relevant adaptation of drive motor and gearing to one another, electrical drives in different power ranges, comprising different usable rotational speeds and torques and in different exterior dimensions can be produced.

In one option, which, for example, is used to drive a windshield wiper unit of the motor vehicle, a rotor of the electrical drive motor and a worm shaft of a worm gear run on a common shaft. The common shaft is normally supported with shaft bearings on both sides of the electrical drive motor. In one modification, a third bearing exists on the end of the common shaft, which faces the worm shaft. The gearing engagement between the worm shaft and the worm wheel is thereby additionally supported and is no longer solely dependent on the torsional stiffness of the worm shaft; however, vibrational and torsional stresses of the rotating shaft can be more easily transmitted via the medial bearing through the use of the three shaft bearings.

It is the aim of the invention to provide an electrical drive which has an improved bearing support of the shaft thereof.

### SUMMARY OF THE INVENTION

According to the invention, an electrical drive comprises a worm gear having a worm shaft and a drive motor having a rotor. The rotor and the worm shaft are arranged on axial sections of a shaft. The electrical drive furthermore comprises two shaft bearings on which the shaft is received, only one of said shaft bearings being arranged on the shaft in the vicinity of the rotor.

The opportunity advantageously ensues therefrom for installation space to be saved and for a distribution of shaft bearings on the shaft to be implemented such that the bearings are subjected to less stress due to shorter levers and can therefore be expected to have a longer service life.

The shaft bearing which is not in the vicinity of the rotor can be arranged on a side of the worm shaft facing away from the rotor. Two alternative layout possibilities result therefrom for the shaft bearing arranged on the shaft in the vicinity of the rotor. In a first embodiment, said shaft bearing lies between the rotor and the worm shaft. The end of the worm shaft on which the rotor is arranged is thereby supported only on one side (also: “cantilevered” or “overhung”), and therefore the required installation space for the electrical drive can be reduced. In the second embodiment, the bearing can be arranged on a side of the rotor facing away from the worm shaft. In so doing, the shaft is supported at both ends thereof, whereby an advantageous reduction of leverage forces result when loads are applied to the shaft during the operation of the electrical drive.

The drive motor can be a brushless DC motor. A motor of this kind requires less installation space along the shaft. This can lead to a further reduction in installation space for the electrical drive.

The electrical drive can further comprise a housing, in which the shaft bearings and a stator of the drive motor are arranged. A further reduction in installation space can be achieved by integrating the stator into the housing. In addition, an improved protection of the drive motor from contamination and vibration can thereby be achieved.

A sensor for determining a rotatory position of the rotor in the housing can furthermore be mounted in the housing. A sensor of this kind can particularly be used in connection with a brushless DC motor as drive motor in order to implement an electrical control of said brushless DC motor. The sensor is protected by the housing from harmful environmental influences, such as heat, vibrations and dust.

### BRIEF DESCRIPTION OF THE DRAWINGS

The invention is described in detail below with reference to the accompanying figures, in which:

FIG. 1 shows an electrical drive having a brushless electric motor;

FIG. 2 shows a modification to the electrical drive from FIG. 1 and

FIG. 3 shows an electrical drive having a commutated electric motor.

### DETAILED DESCRIPTION

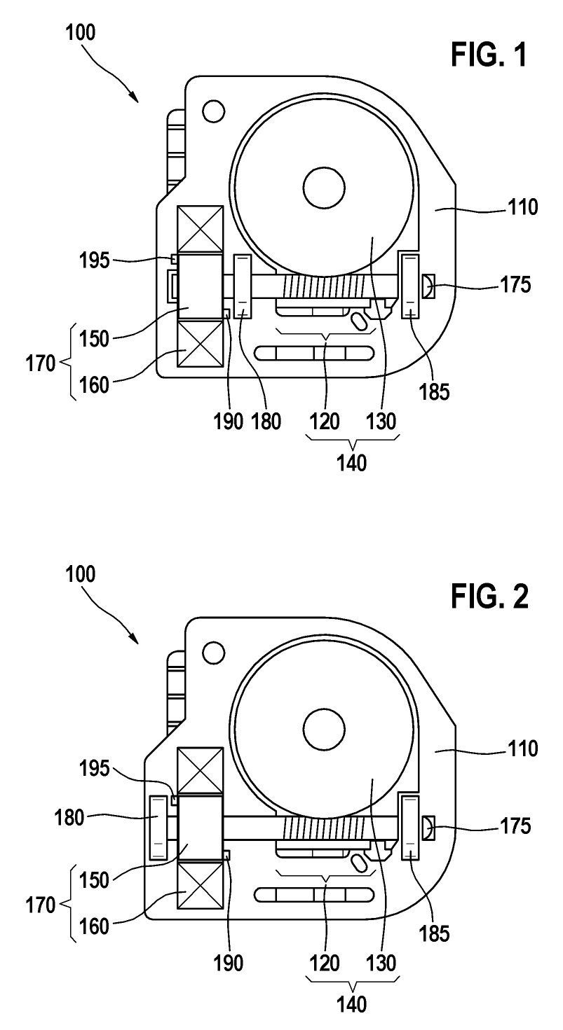

FIG. 1 shows an electrical drive 100 having a brushless electric motor. The electrical drive 100 comprises a housing 110 in which the components of the electrical drive 100 are received. A worm shaft 120 and a worm wheel 130 together form a worm gear 140. A rotor 150 and a stator 160 together form a drive motor 170. The rotor 150 and the worm shaft 120 are arranged axially one behind the other on a shaft 175. A first shaft bearing 180 is arranged on the shaft 175 between the rotor 150 and the worm shaft 120. A second shaft bearing 185 is situated on the right end of the shaft, on a side of the worm shaft 120 which faces away from the rotor 150 of the drive motor 170. A first position sensor 190 and a second position sensor 195 detect a rotatory position, a rotational speed and/or a rotational direction of the rotor 150.

The shaft 175 is normally manufactured from steel. The first shaft bearing 180 and the second shaft bearing 185 can, for example, be roller bearings, in particular ball bearings or even friction (slide) bearings as, for example, self-lubricating bearings. The worm shaft 120 can be integrally embodied with said shaft 175 and the worm thread can be rolled onto said shaft 175 or cut into said shaft 175. In a further embodiment, the worm thread can be a separate element connected axially or radially to said shaft 175. The worm shaft 120 can thereby consist of a different material than the shaft 175, in particular plastic. The material of the worm wheel 130 is selected as a function of the material properties of the worm shaft 120 and the forces to be expected during the operation of the electrical drive 100. The worm wheel 130 can also be manufactured from plastic.

The drive motor 170 is a brushless DC motor having an internal rotor 150. This type of electric motor can require less installation space, particularly in the axial direction, in comparison with a commutated DC motor in a comparable power range. At the same time, the space requirement in the radial direction can be enlarged with respect to the commutated DC motor. The rotor 150 of the drive motor 170 can, for example, be pressed or shrunk onto the shaft 175 or connected in another manner to said shaft. Said rotor 150 carries a number of permanent magnets and if applicable an inference ring, and the stator 160 carries a number of coil windings for generating interacting magnetic fields. Depending on the electrical activation of the coil windings, the permanent magnets of the rotor strive to align themselves into a certain rotatory position with respect to the stator. When the coils of the stator 160 are electrically activated in a suitable manner, the rotor 150 rotates about an axis of rotation of the shaft 175 in a predefined direction at a predefined speed.

In order to be able to implement the activation of the stator 160 as a function of a rotatory position of the rotor 150, the rotatory position of said rotor 150 can be determined. The first position sensor 190 and/or the second position sensor 195 can, for example, be used for this purpose. Installation positions, which are different from those depicted, for the position sensors 190 and 195 between said rotor 150 and the housing 110 are likewise possible and not depicted in FIG. 1.

The coils of the stator 160 are activated during operation of the electrical drive 100 on the basis of the determined rotatory position of the rotor 150 such that the rotor 150 rotates and drives the shaft 175. Radial and axial forces on said shaft 175 are supported by the shaft bearings 180 and 185 on the housing 110. Said shaft 175 drives the worm shaft 120 which thereupon moves the worm wheel 130 about the axis of rotation thereof.

Through the use of the worm gear 140, the electrical drive 100 is designed in a self-locking manner; and therefore when the drive motor 170 is switched off, an external torque acting on the worm wheel 130 is not capable of causing the rotor 150 to rotate.

FIG. 2 shows a modification to the electrical drive from FIG. 1. The essential difference between the electrical drive 100 from FIG. 2 and the electrical drive from FIG. 1 is that the first shaft bearing 180 is arranged in FIG. 2 at a left end of the shaft 175 instead of between the worm shaft 120 and the rotor 150 as in FIG. 1. It could thereby be necessary to design the electrical drive according to FIG. 2 slightly longer along the shaft 175 than the electrical drive 100 from FIG. 1. On the other hand, the arrangement of the first shaft bearing 180 shown in FIG. 2 has the advantage of supporting the shaft 175 in a more precise and resilient manner on account of the extended distance between said first shaft bearing 180 and the second shaft bearing 185. In addition, flexural vibrations in the shaft 175 are not transferred by said first shaft bearing 180, and therefore a resonance frequency of said shaft 175 is reduced with respect to the flexural vibrations.

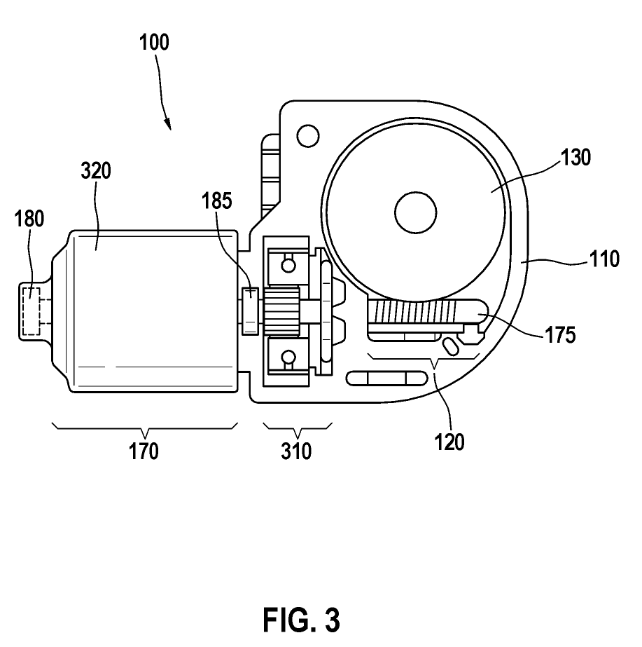

FIG. 3 shows an electrical drive 100 having a commutated electric motor. The embodiment of the electrical drive 100 depicted in FIG. 3 is used for comparison with the electrical drives 100 from FIGS. 1 and 2. The drive motor 170 is commutated, i.e. brushes 310 are provided, in order to activate the coils in the interior of the drive motor 170 as a function of a rotatory position of the shaft 175. Position sensors 190 and 195 from FIGS. 1 and 2 are not required for this purpose.

The first shaft bearing 180 is situated at a left end of the shaft 175 and is supported at an outer shell 320 of the drive motor 170. The second shaft bearing 185 is arranged on the shaft 175 between the drive motor 170 and the brushes 310.

Because the commutated drive motor is constructed as a matter of the principle involved relatively long along the shaft 175 and due to the additional space requirement for the brushes 310, a displacement of the electrical drive 100 in the axial direction is greater than that of the electrical drives 100 pursuant to FIGS. 1 and 2. Furthermore, the distance between the right end of the worm shaft 120 and the nearest shaft bearing 185 is greater than in the electrical drives 100 pursuant to FIGS. 1 and 2, whereby the shaft 175 has to be formed more rigidly to achieve the same load bearing capacity.

1. An electrical drive (100) comprising:
a worm gear (140) having a worm shaft (120);
a drive motor (170) having a rotor (150);
wherein the rotor (150) and the worm shaft (120) are arranged on axial sections of a shaft (175), and
two shaft bearings (180, 185) on which the shaft (175) is received, characterized in that,
only one of the shaft bearings (180) is arranged on said shaft (175) in the vicinity of the rotor (150).

2. The drive (100) according to claim 1, characterized in that the other of the two shaft bearings (185) is arranged on a side of the worm shaft (120) facing away from the rotor (150).

3. The drive (100) according to claim 1, characterized in that the drive motor (170) is a brushless DC motor.

4. The drive (100) according to claim 1, characterized in that the shaft bearing (180) arranged on the shaft (175) in the vicinity of the rotor (150) is arranged between said rotor (150) and the worm shaft (120).

5. The drive (100) according to claim 1, characterized in that the shaft bearing (180) arranged on the shaft (175) in the vicinity of the rotor (150) is arranged on a side of said rotor (150) facing away from the worm shaft (120).

6. The drive (100) according to claim 1, characterized by a housing (110), in which the shaft bearings (180, 185) and a stator (160) of the drive motor (170) are mounted.

7. The drive (100) according to claim 6, characterized in that a sensor (190, 195) for determining a rotary position of the rotor (150) is mounted in the housing (110).

8. The drive (100) according to claim 2, characterized in that the drive motor (170) is a brushless DC motor.

9. The drive (100) according to claim 8, characterized in that the shaft bearing (180) arranged on the shaft (175) in the vicinity of the rotor (150) is arranged between said rotor (150) and the worm shaft (120).

10. The drive (100) according to claim 9, characterized by a housing (110), in which the shaft bearings (180, 185) and a stator (160) of the drive motor (170) are mounted.

11. The drive (100) according to claim 10, characterized in that a sensor (190, 195) for determining a rotary position of the rotor (150) is mounted in the housing (110).

12. The drive (100) according to claim 8, characterized in that the shaft bearing (180) arranged on the shaft (175) in the vicinity of the rotor (150) is arranged on a side of said rotor (150) facing away from the worm shaft (120).

13. The drive (100) according to claim 12, characterized by a housing (110), in which the shaft bearings (180, 185) and a stator (160) of the drive motor (170) are mounted.

14. The drive (100) according to claim 13, characterized in that a sensor (190, 195) for determining a rotary position of the rotor (150) is mounted in the housing (110).
